(19) United States
(12) Patent Application Publication
(10) Pub. No.: US 2025/0285095 A1
(43) Pub. Date: Sep. 11, 2025

(54) EPHEMERAL MOBILE APP CONFIGURED FOR EXCHANGE OF GOODS

(71) Applicant: Averigo LLC, Cerritos, CA (US)

(72) Inventor: Wilfred MARTIS, Cerritos, CA (US)

(21) Appl. No.: 19/219,443

(22) Filed: May 27, 2025

Related U.S. Application Data
(63) Continuation-in-part of application No. 18/351,081, filed on Jul. 12, 2023.
(63) Continuation-in-part of application No. 18/177,016, filed on Mar. 1, 2023, now Pat. No. 12,340,359.
Application No. 18/177,016 is a continuation-in-part of application No. 17/522,351, filed on Nov. 9, 2021, now Pat. No. 11,620,625.
Application No. 17/522,351 is a continuation of application No. 16/428,486, filed on May 31, 2019, now Pat. No. 11,182,763.
(60) Provisional application No. 62/682,112, filed on Jun. 7, 2018.

(51) Int. Cl. G06Q 20/20; G07C 9/00; H04W 12/04

(52) U.S. Cl. CPC G06Q 20/206; G07C 9/00309; H04W 12/04; G07C 2009/00325

(57) ABSTRACT

The present invention provides a method for connecting to a communication network associated with a micro market. The method includes scanning a code associated with an ephemeral app to be downloaded to a mobile communication device. In an example, the method includes associating a web address with a code to find the ephemeral app and linking the web address with the mobile device. In an example, the method includes transferring the ephemeral app in a first format using the Internet to a storage location on the mobile communication device, and initiating the ephemeral app onto the mobile device to open the ephemeral app. The method includes sensing for a Bluetooth beacon associated with a spatial area of one of the micro markets and connecting using the Internet to a server associated with the micro market to transfer the catalog and list of items associated with the micro market.

### CROSS-REFERENCE TO RELATED APPLICATIONS

This application is a Continuation-in-Part of and claims priority to U.S. patent application Ser. No. 18/351,081, filed on Jul. 12, 2023, which is incorporated by reference in its entirety. This application is also a Continuation-in-Part of and claims priority to U.S. patent application Ser. No. 18/177,016, filed Mar. 1, 2023, which is a continuation-in-part of U.S. patent application Ser. No. 17/522,351 filed, Nov. 9, 2021, and issued as U.S. Pat. No. 11,620,625 on Apr. 4, 2023, which is a continuation of U.S. patent application Ser. No. 16/428,486, filed May 31, 2019, and issued as U.S. Pat. No. 11,182,763 on Nov. 23, 2021, which claims priority to U.S. Provisional Application No. 62/682,112, filed on Jun. 7, 2018, each of which is hereby incorporated by reference in their entirety.

### BACKGROUND OF INVENTION

Conventional merchants have implemented various techniques to purchase food goods from a store and check out. As an example, self-checkout scanning is becoming more popular in many stores. Customers can scan the barcode (or QR code, or other specialized codes) of the product themselves and then pay using a credit or debit card, or through a mobile payment app. Safeway and others have self-checkout scanning lanes, which were more productive than human based cash registers. However, a major drawback is that some customers might struggle with scanning the barcodes or finding the right codes for some products, which can slow down the checkout process. Another drawback is that self-checkout systems may have technical issues or malfunctions that can cause frustration for customers.

Alternatively, many stores offer mobile apps that allow customers to purchase items and pay through the app. Customers can scan the barcodes of the products and then pay using a credit or debit card linked to the app. However, a major drawback is that some customers may not want to download yet another app on their phone or may not have a compatible smartphone. Also, if the app or the store's payment system experiences technical difficulties, customers may not be able to complete their purchases.

Customers can pay for their purchases using a conventional credit or debit card at the checkout counter. Credit cards have become widely used over the past forty years. One major drawback is that some customers may not have a credit card or may not want to use one for security reasons. Also, some stores may have slow or outdated payment processing systems, which can cause long wait times for customers.

Cash payment still works in some places. That is, customers can pay for their purchases using cash at the checkout counter. One major drawback is that cash transactions require more time and can slow down the checkout process, especially if the customer does not have exact change. Also, some stores may not accept large bills or may not have enough change on hand, which can be frustrating for customers. More recently, the COVID pandemic stopped the use of cash in many places for health and safety reasons.

In summary, each payment method has its own advantages and disadvantages. Self-checkout scanning and mobile payment apps are generally faster and more convenient but may have technical issues or be difficult to use for some customers. Conventional credit card payment and cash payment are still widely used but can be slower and less convenient, especially during busy times or if the customer does not have exact change.

From the above, it is seen that techniques to improve ways to transact for products are desired.

### SUMMARY OF THE INVENTION

According to the present invention, techniques related generally to processing of secured transactions are provided. In particular, the invention provides a method and system for using a wireless beacon to initiate a secure transaction using a micromarket and a ephemeral application configured for the secure transaction. Merely by way of example, the invention has been applied to a mobile computing device configured to a world wide network of computers, however, the invention has many other applications.

An ephemeral app for purchasing goods on a mobile phone could be called “QuickBuy.” It is designed to be fast, lightweight, and easy to use. Download time for QuickBuy would be relatively short, as the app is designed to be lightweight and efficient. The exact download time would depend on the user's internet connection speed, but it should not take more than a few seconds to download and install. The app size would also be small, preferably 10 MB or less, to download quickly and reduce the amount of storage space it takes up on the user's device. This would make it easy for users to download and use the app, even if they have limited storage space on their phone. QuickBuy would be designed with ease of use in mind, with a simple and intuitive interface that allows users to quickly scan and purchase the items they need. It would have a search function that allows users to find products easily, and a checkout process that is quick and easy to complete.

To further enhance ease of use, QuickBuy could also integrate with popular payment platforms such as PayPal or Apple Pay or Google Pay, allowing users to make purchases with just a few taps on their phone screen. Overall, QuickBuy would be an efficient and user-friendly app that is designed to make mobile purchasing quick and easy.

In an example, the described ephemeral app provides one or several benefits for shoppers, including but not limited to:
1. Simplicity: The app clip or instant app eliminates the need for users to download a dedicated app, create an account, or add debit/credit card information. This makes the shopping experience much simpler and more streamlined, reducing the time and effort required to make a purchase.
2. Speed: With the ability to identify nearby markets and product catalogs automatically, shoppers can purchase products in a matter of seconds. This saves valuable time, making the shopping experience more convenient and efficient.
3. Security: By using the shopper's secure mobile wallet, such as Apple Pay, Google Pay, or Samsung Pay, the app provides an additional layer of security for online transactions. The app does not require debit/credit card information to be entered, which can reduce the risk of fraud or identity theft.

Overall, the described app offers a convenient, efficient, and secure shopping experience for users, making it an attractive option for shoppers who value simplicity, speed, and security. In other examples, the present system can also maintain user analytics, use history, and other information that can be personally used by the user, or collected in bulk. Of course, there can be other benefits, or advantages in other examples.

The above examples and implementations are not necessarily inclusive or exclusive of each other and may be combined in any manner that is non-conflicting and otherwise possible, whether they be presented in association with a same, or a different, embodiment or example or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above examples implementations are illustrative, rather than limiting.

### BRIEF DESCRIPTION OF THE DRAWINGS

FIG. 1 is a simplified diagram of a geographic region of a private office building according to an example.

FIG. 2 is a simplified diagram of a geographic region of a private office building with a micro market according to an example.

FIG. 3 is a simplified diagram of a geographic region of a private office building with a micro market according to an example.

FIGS. 4 and 5 are simplified diagrams of a hotel micromarket according to an example.

FIG. 6 is a simplified network diagram of a micromarket system according to an example.

FIG. 7 is a more detailed diagram of a micromarket server device according to an example.

FIG. 8 is a more detailed diagram of a micromarket wireless transmitter device according to an example.

FIG. 9 is a more detailed diagram of a micromarket application according to an example.

FIG. 10 is a detailed diagram of an overall system architecture according to an example.

FIGS. 11 to 13 are various user interfaces for the micromarket application according to an example.

FIG. 14 is a simplified diagram of a database schema according to an example.

FIG. 15 is a simplified diagram illustrating a transaction process according to an example.

FIG. 16 illustrates simplified user interfaces to download and use the present app according to an example.

### DESCRIPTION OF EXAMPLES

According to the present invention, techniques related generally to processing of secured transactions are provided. In particular, the invention provides a method and system for using a wireless beacon to initiate a secure transaction using a micromarket and a ephemeral application configured for the secure transaction. Merely by way of example, the invention has been applied to a mobile computing device configured to a world wide network of computers, however, the invention has many other applications.

As background, shoppers are often required to complete two tasks to purchase products at a market. In an example, the shopper builds a shopping cart with desired products, and then pays for the products at checkout. In an example, many shoppers now prefer to use their smartphones, especially if they are only purchasing a few products, e.g., at a hotel lobby market, an office micro-market, an airport store. Unfortunately, a conventional mobile app may require a shopper to perform time consuming steps of downloading the app, creating an account, and adding a debit/credit card before building the shopping cart and paying for the products. The time consuming steps are often unappealing if the shopper plans to shop at that market only once or twice, or for a short period, e.g., a hotel guest, an office visitor, an air traveler.

In an example, an ephemeral app such as the Apple App Clip or Android Instant App is a small-sized mobile application that utilizes the smartphone's Bluetooth connection to read a nearby Bluetooth beacon's unique ID from a micro market. This unique ID helps the application to identify the nearby micro market and its associated product catalog that includes products, prices, taxes, container deposits, and other information. In an example, one of the main features of this app is that it automatically selects the nearby market, without requiring the user to manually select it. The single application works at all authorized markets, providing a seamless shopping experience.

In an example, to build the shopping cart with desired products, the application uses the smartphone's camera to scan product barcodes or QR codes. The app also allows users to pay for the products using a debit/credit card stored in their smartphone's digital wallet, such as Apple Pay on an iPhone's wallet, Google Pay on an Android phone's wallet, or Samsung Pay on a Samsung phone's wallet. To ensure user privacy and save storage space, the app can be automatically deleted from the shopper's smartphone by the OS after a period of non-use, such as 30 days for an Apple App Clip.

Preferably, Apple Pay and Google Pay are more secure ways of paying within the ephemeral app. That is, the digital wallet has cards that are verified by the issuing bank, before they are added to the wallet. Additionally, the digital wallet is locked behind the phone's fingerprint sensor or face recognition feature during payment, adding an extra layer of security that physical cards lack. In an example, if the phone is lost, the wallet can be disabled remotely using Find My iphone (iPhone by Apple) or Find My Device (Android by Google), or other techniques. In an example and preferably, the app creator, merchant, or third party does not receive any card or personal information about the user, or shopper. That is, privacy is maintained using the app by the user.

In a preferred example, the merchant has no personal information about the user of the app. Such personal information can include a name, an address, a phone number, or other personal information. The merchant knows the item being purchased, location of purchase, and price and no credit card or banking information. In an example, Apple knows the name of the user but does not know what has been purchased using the app. No single entity knows the name of the person and what has been purchased to preserve privacy for the sale. No single entity has the location of the purchase and the name of the person. As an example, a user could purchase a sensitive product such as a birth control test, condom, or other sensitive product or be at a sensitive location for the purchase. Neither Apple nor the bank nor the merchant knows the name of the user and the item being purchased. By way of using the app, the merchant or the micromarket owner does not know the name of the person purchasing the item or services to create an anonymous purchase of an item or services. The location is anonymous to Apple or the bank.

An example, the present invention provides an App Clip characterized as an ephemeral application. The application is downloaded by scanning a QR code or App Clip code using the camera, or reading an NFC tag from a mobile communication device. The App Clip opens and runs instantly due to its small size, e.g., 10 MB and less. The App Clip has suitable functions for purchasing products at a catalog for a micro market. Once the products have been purchased, the App Clip is removed and disappears from the mobile communication device after a predetermined amount of time of non-use.

In an example, the present method and related system uses a beacon identifier, which is a unique micromarket identification number, to be associated with a merchant identification number and a terminal identification number, each of which is pre-stored in memory on a secured server.

In an example, the present invention provides a local area network system for a micro-market application. The system has a world wide network of computers, which comprising the Internet. In an example, the system has a micro market server device coupled to the world wide network of computers. In an example, the micro market server device has a library comprising a listing of a plurality of products, a field configured with the association information, e.g., an identifier for the server device. In an example, the product information is associated with the plurality of products is provided in a product catalog file. The device has a plurality of fields associated with a plurality of micromarket identification information. The micromarket identification information is a unique identifier for the particular micromarket.

In an example, the system has a spatial region comprising a physical region having an effective radius of less than twenty feet. The system has a micromarket wireless transmitter device configured with identification information comprising an association identification information and a micromarket identification information. In an example, the micromarket wireless transmitter device is spatially disposed within the spatial region.

The wireless transmitter is configured to transmit a beacon comprising wireless signal having a frequency ranging from 2 GHz to 3 GHZ, among others. In an example, the wireless transmitter device is configured with a Bluetooth device having a frequency of 2.4 GHz or other frequencies. In an example, the micromarket wireless transmitter is physically attached to a back of a shelf of the micromarket to physically secure the micromarket wireless transmitter, and to be out of sight of any user of the micromarket. The wireless transmitter can be self powered via a battery or other energy source, or be plugged into a power source via a USB connection or other interface.

The system has a geofence region configured within a vicinity of the spatial region and derived from a perimeter of the wireless signal. As used herein, the term geofence is a virtual perimeter for a real-world geographic area derived from the perimeter of the wireless signal or beacon. A geo-fence could be dynamically generated—as in a radius around a point location, or a geo-fence can be a predefined set of boundaries (such as school zones or neighborhood boundaries). The use of a geo-fence is called geo-fencing, and one example of usage involves a location-aware device of a location-based service (LBS) user entering or exiting a geo-fence. This activity could trigger an alert to the device's user as well as messaging to the geo-fence operator. This info, which could contain the location of the device, could be sent to a mobile telephone or an email account. See, Wikipedia.org.

In an example, the system has a micro market comprising a shelf configured with a wireless lock. The shelf having a plurality of products to be displayed. In an example, the system has a mobile wireless device of a user. The mobile wireless device comprises a processor device, a memory device, and a receiver for a local area network and a transceiver for communication to the world wide network of computers. The mobile wireless device can be a cell phone, such as a Smart Phone, tablet, or other computing device configured with a wireless transceiver.

In an example, the system has a micromarket application configured with the processor device to receive the association information and the micromarket identification information regarding the plurality of products within the geofence, when the mobile wireless device is within the geofence region by movement of the user, and initiates a connection with the wireless transmitter device, and upon the input of the association information and the micromarket identification to the micromarket application, the micromarket application initiates connection to the micro market server device which is configured to transfer product information regarding the plurality of products to the micromarket application.

In an example, an image capturing device is provided in the mobile wireless device, and is coupled to the micromarket application, and is configured to receive a UPC code associated with at least one of the plurality of products. In an example, the micromarket application is configured to transfer purchase information regarding the product into a shopping cart configured with the micromarket application and check out the product in exchange for a payment obligation for the product.

In an example, the micromarket application comprises a security module. In an example, the security module is configured to transfer a key to the wireless lock when the product has been checked out in exchange for the payment such that the wireless lock is released to allow the user to remove the product from the micromarket.

In an example, the system further comprises a security module. The security module is configured to transfer a key using a 2.4 GHz wireless signal or other signal related to Bluetooth to the wireless lock when the product has been checked out in exchange for the payment such that the wireless lock is released to allow the user to remove the product from the micromarket. In an example, the key can be configured with the lock to release the product that is to allow the user to remove it for viewing and scanning. Once the lock is latched, and secures the product after payment, and the product has been removed.

In an example, the system further comprises an alert module configured to transfer an alert from the micromarket server to the micromarket application once connection has been established between the micromarket application and the micromarket wireless transmitter device. In an example, the alert module is provided in the micromarket server. In an example, the alert module is configured to transfer an alert from the micromarket server to the micromarket application once connection has been established between the micromarket application and the micromarket wireless transmitter device. The alert is associated with one of the plurality of products.

Further details of the present system and related method can be found throughout the present specification and more particularly below.

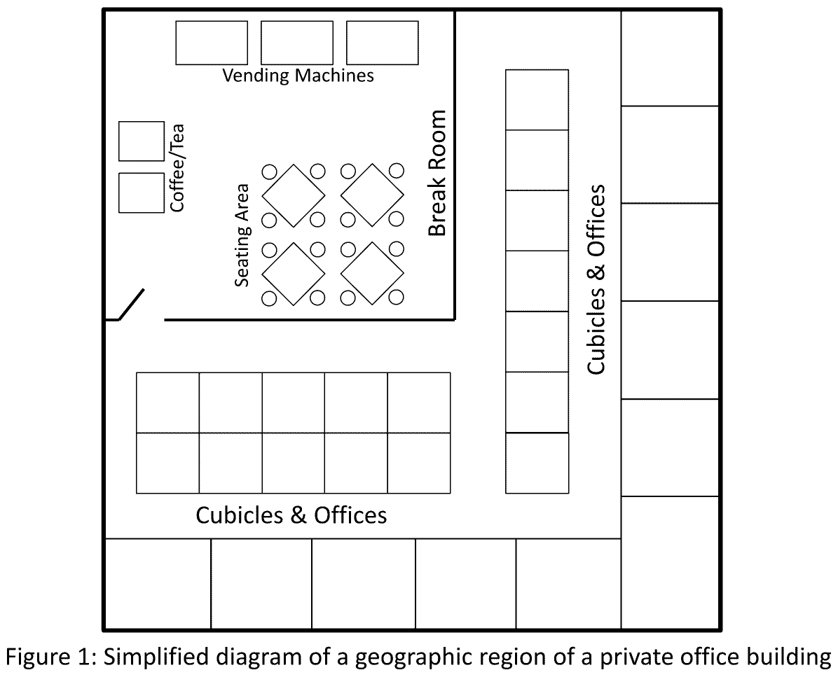

FIG. 1 is a simplified diagram of a geographic region of a private office building according to an example. As shown, the private office building is often within a private office area with a plurality of users. In an example, each of the users is an employee of a company. In an example, the private office area is free from any kiosk or other vending machine or may have a kiosk. In this private office building, there is limited use of any micromarket and the kiosk is heavily used during lunch and other breaks.

In an example, the region has shelves, and a refrigerator, each of which is packed with drinks, snacks, food, and other items to eat. Employees take them for free, and the company does not charge for them. In some cases, some employees take more than their fair share, and pack them away for the weekend.

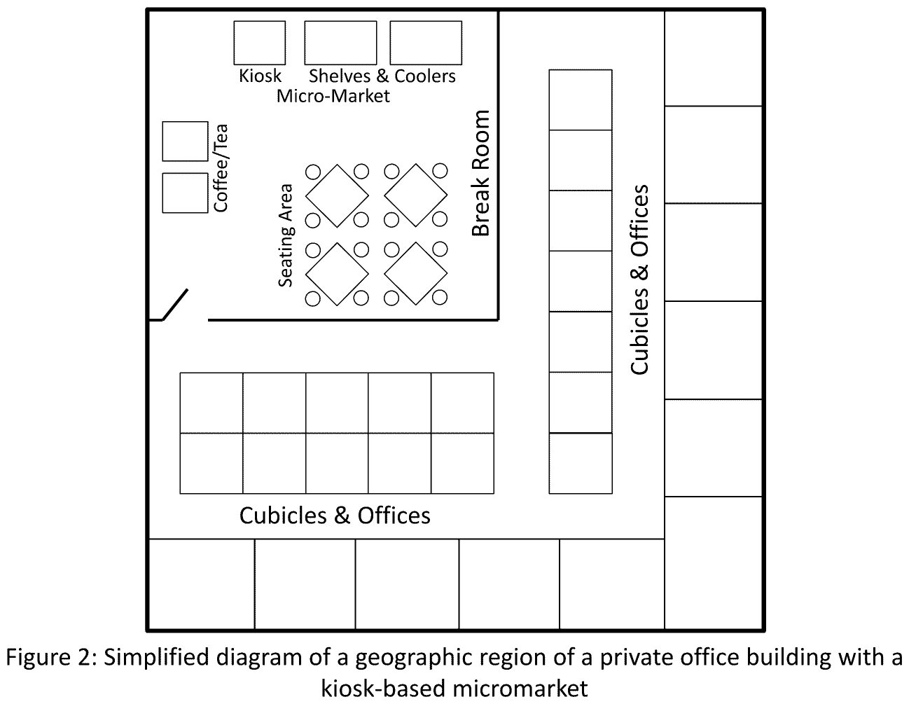

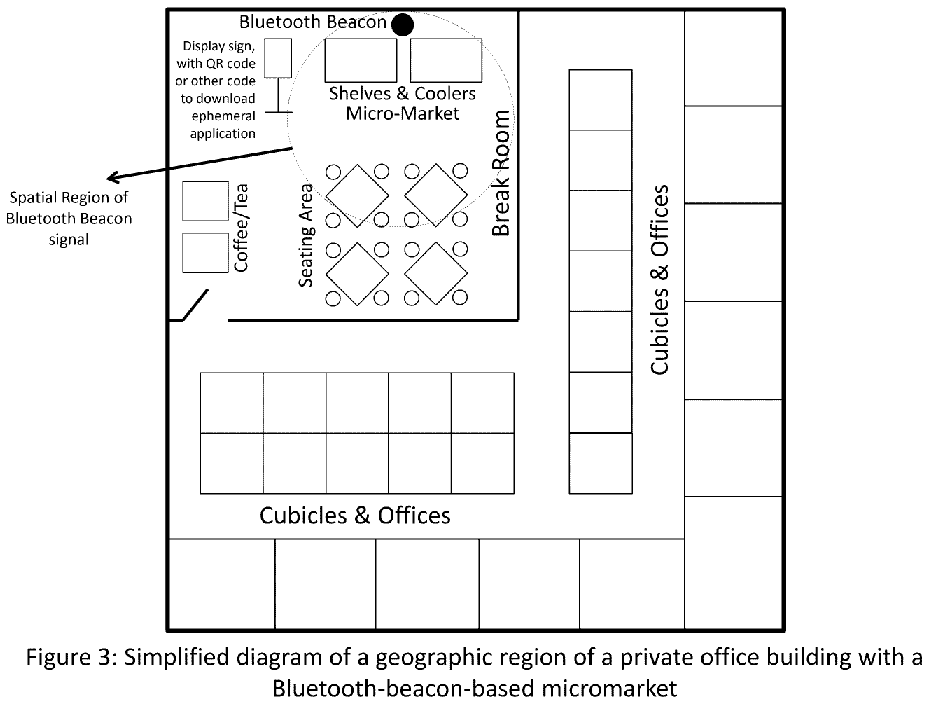

FIG. 2 is a simplified diagram of a geographic region of a private office building with a kiosk based micro market according to an example, and FIG. 3 is a simplified diagram of a geographic region of a private office building with a micro market according to an example. As shown, the private office building is often within a private office area with a plurality of users. In an example, each of the users is an employee of a company. In an example, the private office area is free from any kiosk or other vending machine or may have a kiosk. In this private office building, a present micromarket system including a micromarket wireless transmitter device is included.

In an example, the micromarket wireless transmitter device is spatially disposed in a hidden area. In an example, the micromarket wireless transmitter is physically attached to a back of a shelf (or plugged into an outlet within a vicinity of the micromarket) of the micromarket to physically secure the micromarket wireless transmitter, and to be out of sight of any user of the micromarket.

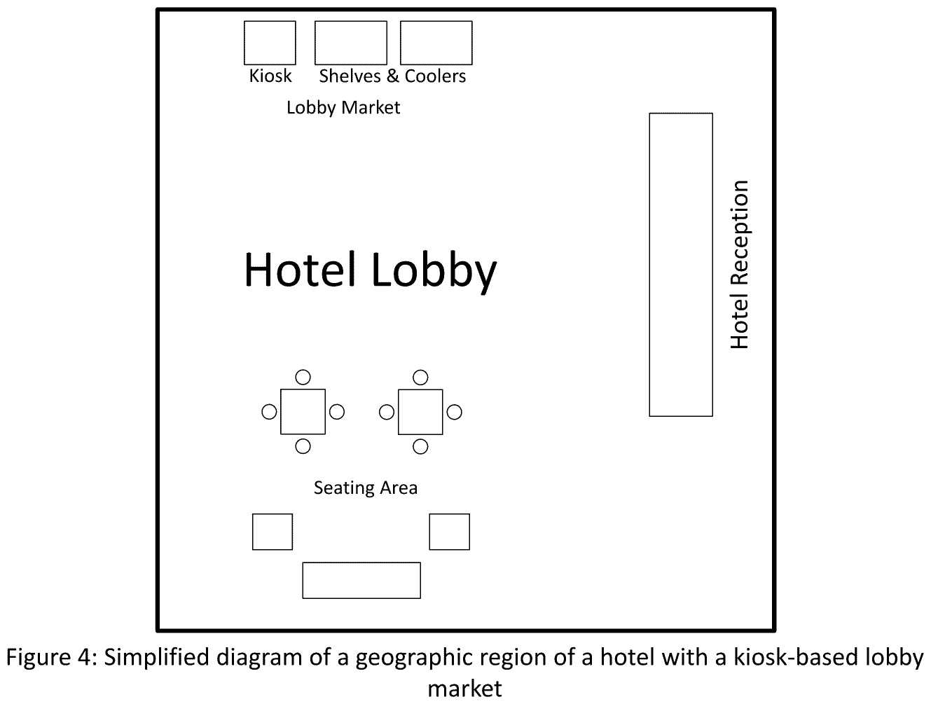

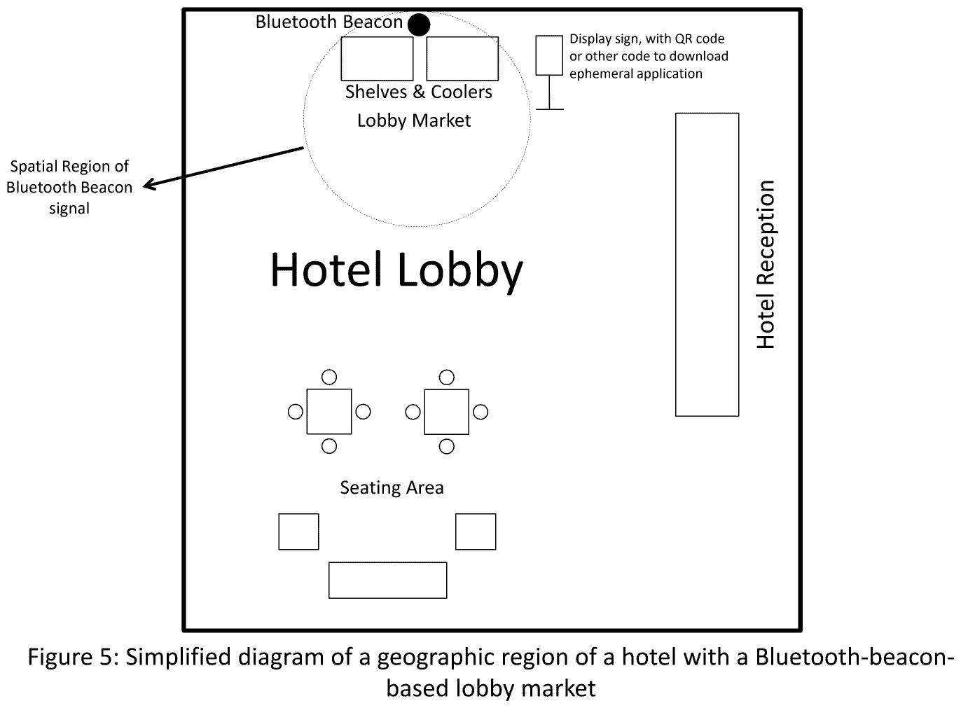

FIGS. 4 and 5 are simplified diagrams of a hotel micromarket according to an example. As shown is a hotel lobby, including common elements such as a reception, seating area, and other elements in a spatial region. The lobby can also include a lobby market, including a self-checkout kiosk, shelves, and coolers, each of which is filled with products. As also shown, the lobby can be configured with a beacon covering a certain geographic region and a display sign with a QR code, App Clip code or other identifier to download the present ephemeral app.

Once the app has been loaded on the mobile phone, the app self-configures within a short period of time and allows for a user to purchase products, as described.

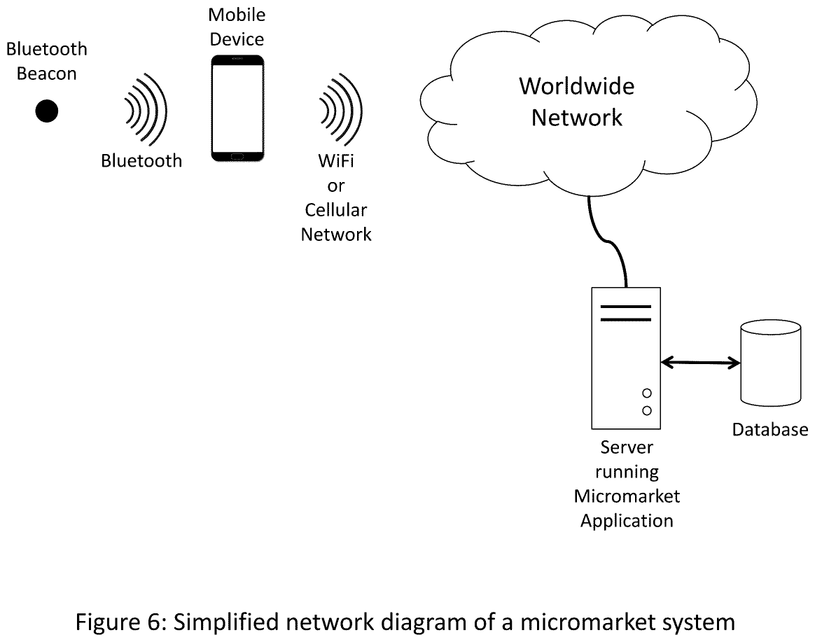

FIG. 6 is a simplified network diagram of a micromarket system according to an example. In an example, a local area network system for a micro-market application is provided. The system has a world wide network of computers, as shown. The world wide network of computers comprising the Internet, and any other interconnected network system.

In an example, the network is coupled to a micro market server device. In an example, the micromarket server has various elements. In an example, the micromarket server has a database. The database has a library comprising a listing of a plurality of products. In an example, the database has a field configured with the association information. In an example the association information is an identifier for the server device to access the present system. In an example, the database has a plurality of fields associated with a plurality of micromarket identification information.

In an example, the micromarket system is configured within a spatial region comprising a physical region having a short range measured by an effective radius. In an example, the effective radius is less than twenty feet, less than fifty feet, less than one hundred feet but can also include other variations. The physical area can be within a cafeteria, an outside region, or other region.

In an example, the system has a micromarket wireless transmitter device configured with identification information comprising an association identification information and a micromarket identification information. In an example, the micromarket wireless transmitter device is spatially disposed within the spatial region. The wireless transmitter is configured to transmit a beacon comprising wireless signal having a frequency ranging from 2 GHz to 3 GHz or other desirable frequencies.

In an example, the system creates a geofence region configured within a vicinity of the spatial region and derived from a perimeter of the wireless signal. That is, the beacon emits wireless signals having a certain range to form the geofence.

In an example, the system has a micro market comprising a shelf configured with a wireless lock, the shelf having a plurality of products to be displayed. The shelf is free and can be accessed by a user, unlike a kiosk or vending machine. In an example, the shelf can be accessed by multiple users without interference of a single interface or gateway of the kiosk or vending machines.

In an example, the system has a plurality of users each of them having a mobile wireless device. In an example, the mobile wireless device is selected from a smart phone, a cellular phone, a tablet computer, or a laptop computer. The mobile wireless device has a transmitter and/or receiver for a telecommunication network, such as 3G, LTE, or 5G. In an example, the device also has a transmitter and/or receiver for a local area network, such as WiFi or an equivalent. In an example, the device has a transmitter/receiver for a personal area networks, such as Bluetooth™ or others. As used herein, the term Bluetooth is a wireless technology standard for exchanging data over short distances (using short-wavelength UHF radio waves in the ISM band from 2.4 to 2.485 GHz) from fixed and mobile devices, and building personal area networks (PANs). Bluetooth is managed by the Bluetooth Special Interest Group (SIG), which has more than 30,000 member companies in the areas of telecommunication, computing, networking, and consumer electronics. The IEEE standardized Bluetooth as IEEE 802.15.1, but no longer maintains the standard. The Bluetooth SIG oversees development of the specification, manages the qualification program, and protects the trademarks. A manufacturer must meet Bluetooth SIG standards to market it as a Bluetooth device. Further details on Bluetooth can be found at https://en.wikipedia.org/wiki/Bluetooth, which is incorporated by reference. In other examples, the device can have a communication interface for a meshed network, such as ZigBee™, ZWave™, or 6LowPan™, and others.

In an example, the mobile wireless device comprising a processor device, a memory device, and a receiver for a local area network and a transceiver for communication to the world wide network of computers.

In an example, the system has a micromarket application configured with the processor device. The process device is configured to receive the association information and the micromarket identification information regarding the plurality of products within the geofence, when the mobile wireless device is within the geofence region by movement of the user. In an example, the application initiates a connection with the wireless micromarket transmitter device. In an example, upon the input of the association information and the micromarket identification to the micromarket application, the micromarket application initiates connection to the micro market server device, which is configured to transfer product information regarding the plurality of products to the micromarket application. Of course, there can be other variations, modifications, and alternatives.

In an example, the mobile wireless device has an image capturing device provided in the mobile wireless device. The image capturing device is coupled to the micromarket application, and configured to receive a UPC code associated with at least one of the plurality of products. The image capturing device acts as a scanner to receive the UPC code in bar code form.

In an example, the micromarket application is configured to transfer purchase information regarding the product into a shopping cart configured with the micromarket application and check out the product in exchange for a payment obligation for the product.

In an example, the micromarket application comprises a security module. In an example, the security module is configured to transfer a key using a 2.4 GHz wireless signal to the wireless lock when the product has been checked out in exchange for the payment such that the wireless lock is released to allow the user to remove the product from the micromarket.

In an example, the micromarket application has an alert module configured to transfer an alert from the micromarket server to the micromarket application once connection has been established between the micromarket application and the micromarket wireless transmitter device. In an example, the alert module is configured to transfer an alert from the micromarket server to the micromarket application once connection has been established between the micromarket application and the micromarket wireless transmitter device. In an example, the alert is associated with one of the plurality of products.

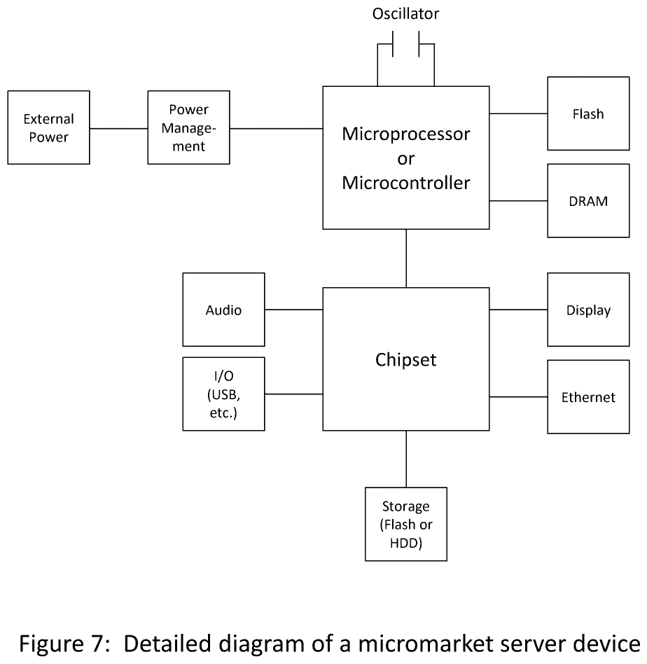

FIG. 7 is a more detailed diagram of a micromarket server device according to an example. As shown, the server device has a microprocessor coupled to a memory resource, including a Flash memory devices, and DRAM devices. The microprocessor is configured with a clock, and chipset to interface between the microprocessor and other peripheral elements such as a display, a network interface (e.g., Ethernet), a fixed or Flash memory storage device, an I/O (e.g., USB), audio, and other peripherals. The server device also has external power and power management. An example can be found on Amazon EC2 instances run on 64-bit virtual Intel processors as specified in the instance type product pages. For more information about the hardware specifications for each Amazon EC2 instance type, see Amazon EC2 Instance Types. However, confusion may result from industry naming conventions for 64-bit CPUs. Chip manufacturer Advanced Micro Devices (AMD) introduced the first commercially successful 64-bit architecture based on the Intel x86 instruction set. Consequently, the architecture is widely referred to as AMD64 regardless of the chip manufacturer. Windows and several Linux distributions follow this practice. This explains why the internal system information on an Ubuntu or Windows EC2 instance displays the CPU architecture as AMD64 even though the instances are running on Intel hardware. Of course, there can be other alternatives, variations, and modifications. See, for example, https://docs.aws.amazon.com/AWSEC2/latest/UserGuide/instance-types.html, which is incorporated by reference.

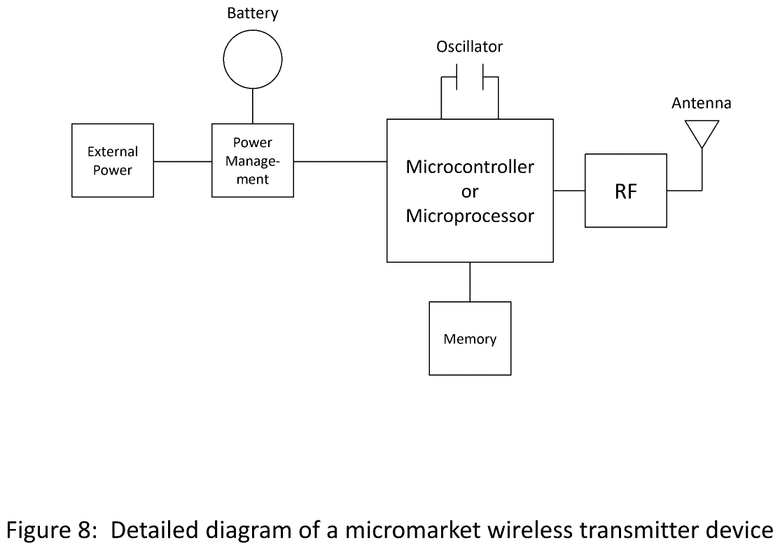

FIG. 8 is a more detailed diagram of a micromarket wireless transmitter device according to an example. As shown, the wireless transmitter has a microprocessor or micro controller device coupled to a memory resource, such as Flash memory or others. In an example, the processing device is coupled to an rf device, which generates, for example, a wireless signal based upon Bluetooth via antenna. The device has an external power source, power management, and battery, which is capable of stand alone operation or can be coupled to a wall outlet via a USB power outlet. An example can be found in at https://en.wikipedia.org/wiki/Bluetooth_low_energy_beacon, which is incorporated by reference.

In an example, a product called RadBeacon USB manufactured by Radius Networks, Inc. can be used. The USB is a fully standalone proximity beacon using iBeacon™, AltBeacon™, and Eddystone™ technology implemented in a tiny USB package that can be powered by any available USB power source. The RadBeacon USB proximity beacon is easy to deploy, easy to maintain, reliable and long-lasting. Of course, there can be other variations, alternatives, and modifications.

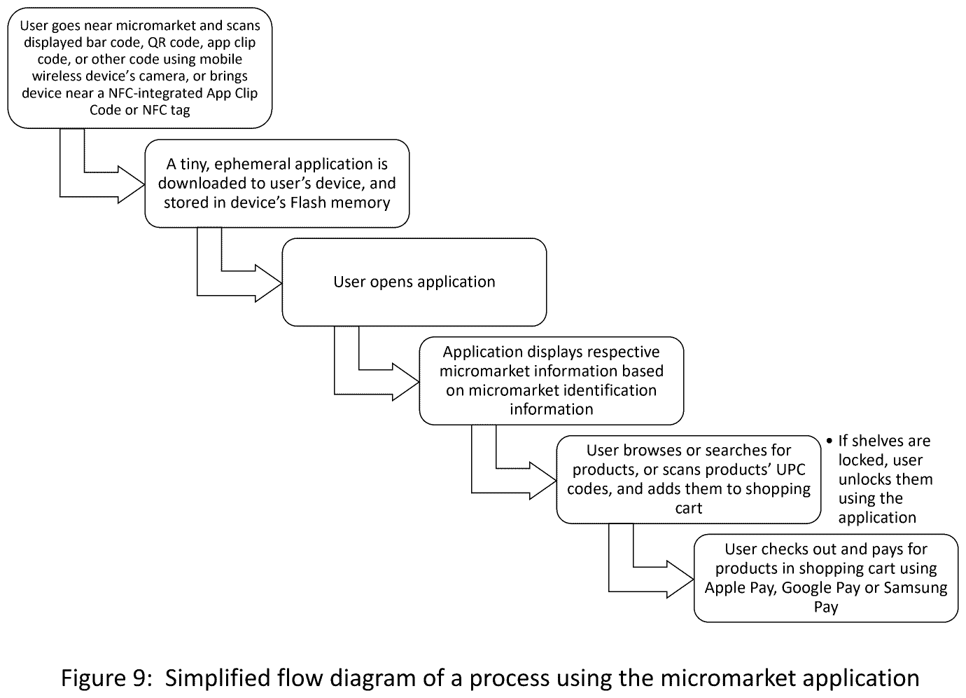

FIG. 9 is a more detailed diagram of a micromarket application according to an example. In an example, the detailed diagram provides for a schema for configuring the present application. As an example, the user moves a mobile wireless device (e.g., iPhone) toward a vicinity of a micromarket, and scans a code, e.g., QR code, App Clip code or other identifier, NFC tag. In an example, a user installs micromarket application or ephemeral app on the mobile wireless device. In an example, a user installs the application from the Apple App Store or the Google Play Store, or other storefront. The user selects the application, enters user information to access the store, and downloads the application onto the user's smart phone or other computing device, and configures the application with the phone settings and other configurations. Of course, there can be other variations, alternatives, and modifications.

In an example, the user does not require to have an account and/or add payment methods in application after it has been installed onto a memory resource of the phone and configured. In an example, the user does not require account information using one or more of a first name, last name, email address, password, physical address, and mobile phone number in some examples. Of course, there can be various alternatives, variations, and modifications.

In an example the user does not need to enter cumbersome payment methods. Of course, there can be other variations, alternatives, and modifications.

In an example, the user goes near micromarket and opens the application. The user opens application within the spatial region of Bluetooth beacon signal, or other suitable beacon signal. In particular, the application connects or pairs with the beacon signal. Of course, there can be other variations, alternatives, and modifications.

In an example, the application displays respective product information based on micromarket identification information. In an example, the application displays location name and address of nearby micro market. In an example, the application fetches available product categories, and names, images, descriptions, and prices of the products available in those categories in the nearby micro market, from the server—e.g. a carbonated beverage category, with the names, images, descriptions and prices of beverages available in that category.

User browses or searches for products, or scans products' UPC codes, and adds them to shopping cart. In an example, the user browses products within the available shopping categories and adds them to shopping cart. The user searches for products by product name in a search box, and adds them to shopping cart. In an example, the user picks up products from the shelves or coolers, scans the UPC barcodes on the packages, and adds them to shopping cart. In an example, the user checks out and pays for products in shopping cart using the added payment method. Of course, there can be other variations, alternatives, and modifications.

In an example, the user checks out and pays for the items in shopping cart, by selecting the Apple Pay, Google Pay or Samsung Pay. Of course, there can be other variations, alternatives, and modifications.

The above examples and implementations are not necessarily inclusive or exclusive of each other and may be combined in any manner that is non-conflicting and otherwise possible, whether they be presented in association with a same, or a different, embodiment or example or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above examples implementations are illustrative, rather than limiting.

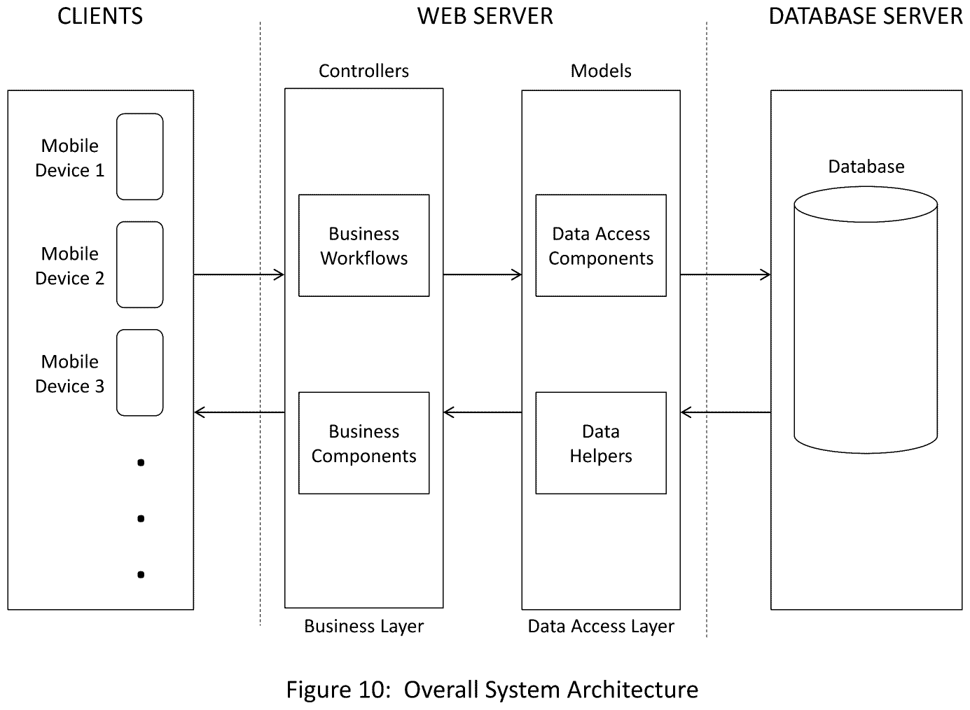

FIG. 10 is a detailed diagram of an overall system architecture according to an example. As shown, the system has a plurality of clients, such as mobile devices, a web server, which can be coupled to each of the clients, and a database server, among other networking elements (not shown). The web server has controllers and models. The controllers include work flows, e.g., business work flows and components, and the modules include data access components, and helpers. A database, which will be further described, configures the present system.

In an example, the present invention provides a local area network system for a micro-market application. The system has a world wide network of computers, which comprising the Internet. In an example, the system has a micro market server device coupled to the world wide network of computers. In an example, the micro market server device has a library comprising a listing of a plurality of products, a field configured with the association information, e.g., an identifier for the server device. The device has a plurality of fields associated with a plurality of micromarket identification information. In an example, the system has a spatial region comprising a physical region having an effective radius of less than twenty feet. The system has a micromarket wireless transmitter device configured with identification information comprising an association identification information and a micromarket identification information. In an example, the micromarket wireless transmitter device is spatially disposed within the spatial region. The wireless transmitter is configured to transmit a beacon comprising wireless signal having a frequency ranging from 2 GHz to 3 GHZ, among others. The system has a geofence region configured within a vicinity of the spatial region and derived from a perimeter of the wireless signal. The system has a micro market comprising a shelf configured with a wireless lock. The shelf having a plurality of products to be displayed. In an example, the system has a mobile wireless device of a user. The mobile wireless device comprises a processor device, a memory device, and a receiver for a local area network and a transceiver for communication to the world wide network of computers. The mobile wireless device can be a cell phone, such as a Smart Phone, tablet, or other computing device configured with a wireless transceiver.

In an example, the system has a micromarket application configured with the processor device to receive the association information and the micromarket identification information regarding the plurality of products within the geofence, when the mobile wireless device is within the geofence region by movement of the user, and initiates a connection with the wireless transmitter device, and upon the input of the association information and the micromarket identification to the micromarket application, the micromarket application initiates connection to the micro market server device which is configured to transfer product information regarding the plurality of products to the micromarket application.

In an example, an image capturing device (e.g., sensor, camera) is provided in the mobile wireless device, and is coupled to the micromarket application, and is configured to receive a UPC code associated with at least one of the plurality of products. In an example, the micromarket application is configured to transfer purchase information regarding the product into a shopping cart configured with the micromarket application and check out the product in exchange for a payment obligation for the product.

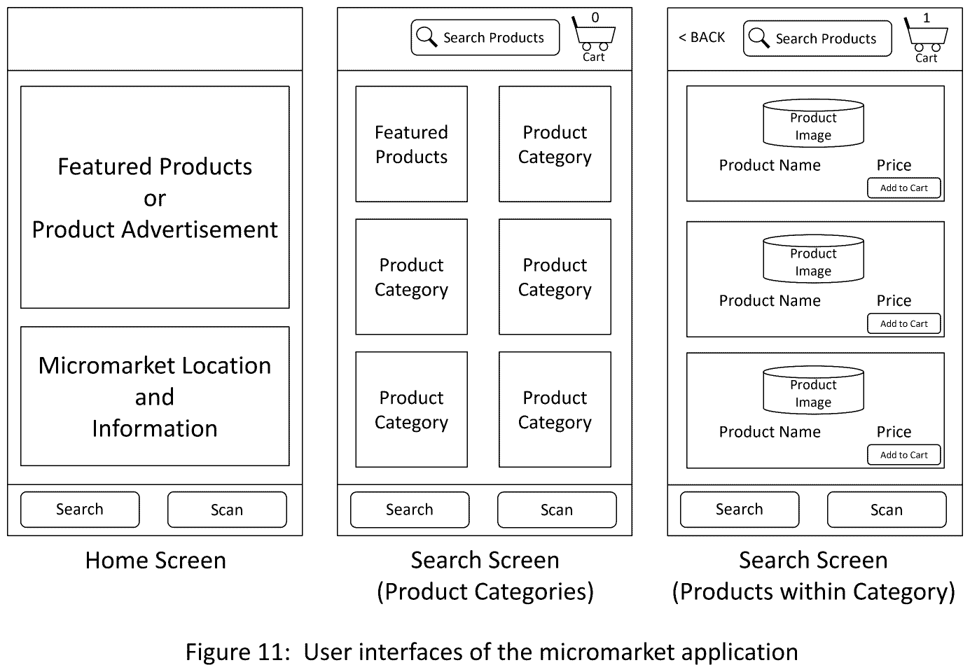

FIGS. 11 to 13 are various user interfaces for the micromarket application according to an example. In an example, FIG. 11 is a simplified illustration of a home screen, a shop screen, and a second shop screen (or panels) on the application. When user opens application within the spatial region of Bluetooth beacon signal, the home screen displays the micro market location name, address and other relevant information at the bottom, and any featured or advertised products or product categories at the top. In an example, the home screen provides a feedback link in header, which user can click to send feedback to the application provider or the micro market operator. In an example, the home screen provides a link to user's account, where user can edit account information. Of course, there can be other variations, alternatives, and modifications.

In an example, the shop screen for Product Categories is illustrated. The shop screen displays all available product categories in the nearby micro market. In an example, the shop screen provides a Search box for user to search for products by name. In an example, the shop screen displays shopping cart in header, with number of products currently in the cart. Of course, there can be other variations, alternatives, and modifications.

In an example, the shop screen for Products within Category is illustrated. In an example, the screen displays all available products within a category, along with name, image and price for each product. In an example, the user can add a product to shopping cart by clicking on the “Add to Cart” button. The screen displays shopping cart in header, with number of products currently in the cart. Of course, there can be other variations, alternatives, and modifications.

In an example, the mobile wireless device has a graphical user interface comprising a plurality of panels. In an example, the plurality of panels has a first panel comprises a featured product region, a micro-market region, and a tool bar having a home icon, a shop icon, a scan icon, a wallet icon, and a history icon. In an example, the interface has a second panel comprising a plurality of product categories spatially disposed within a center region of the second panel and a tool bar having a search icon. In an example, the user interface has a third panel comprising a plurality of product images and related price for each of the product images, and a tool bar comprising a shopping cart. Of course, there can be other variations, modifications, and alternatives.

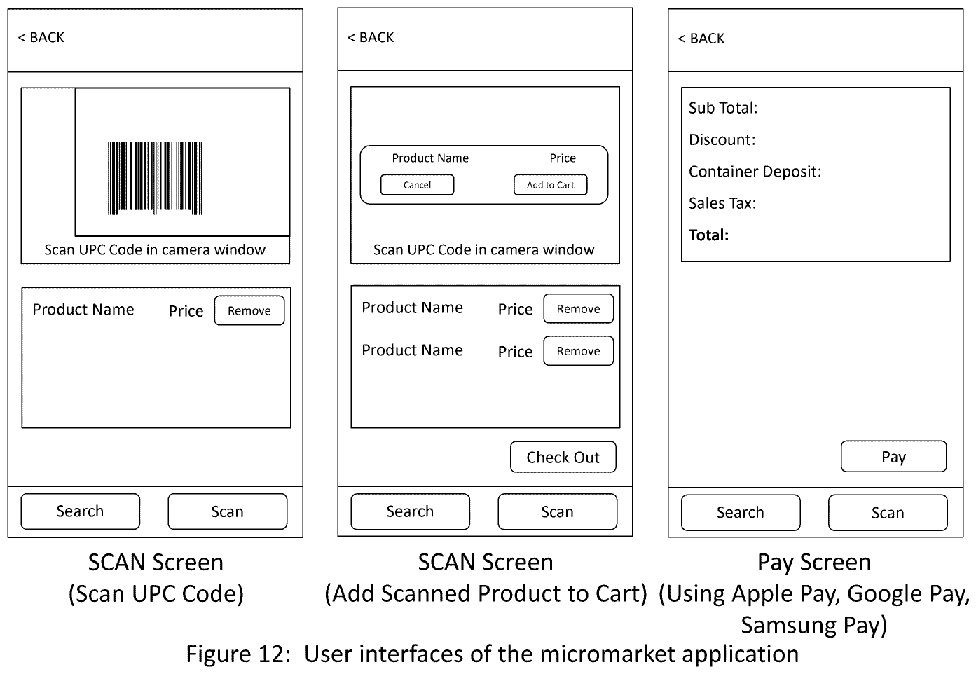

In an example, FIG. 12 illustrates a scan screen, another scan screen for a product, and a shopping cart screen for the application. The scan screen for scanning the UPC code for a product is shown. In an example, the screen is for processing the UPC code for the product, which the user selects. The screen displays a scan window using the mobile device's camera, where user positions UPC code on product package to scan it. Next, the screen has an interface to add the scanned product into a cart, as shown. Once the UPC code on product package is scanned, the user can verify product name and view price, and add product to shopping cart. Of course, there can be other variations, alternatives, and modifications.

Optionally, the application prompts a shopping cart screen. The screen displays all products in shopping cart with individual prices, as well as a total price. Optionally, the user can also remove certain products from shopping cart. Of course, there can be other variations, alternatives, and modifications.

In an example, the screen also has a shopping cart or pay screen portion using Apple Pay, and others.

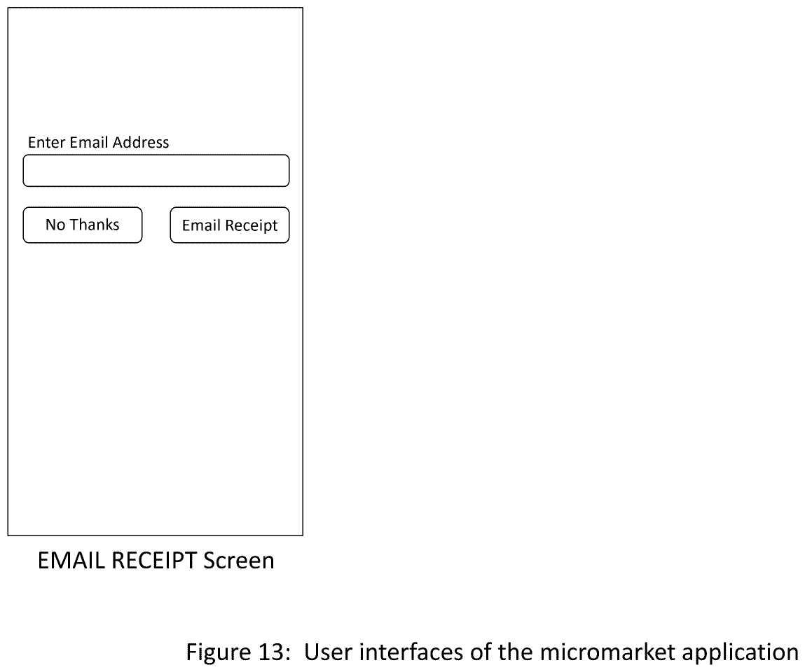

FIG. 13 is an illustration of an optional check out screen for the application. In an example, the check out screen displays an email information slot for a receipt. Of course, there can be other variations, alternatives, and modifications. As shown, the interface has an email screen for check out.

In an example, the application has the wallet screen. The user adds payment methods on the screen, as shown. The user can also view or remove all stored payment methods. In an example, the application has the history screen, which displays user's entire purchase history-order number, date and time of purchase, micro market location name, names and prices of purchased products, and order total. Of course, there can be other variations, alternatives, and modifications.

In an example, the app has been configured with a button to be linked to the wallet including a plurality of cards. Each of the cards have been pre-authorized for a user of the mobile device and app.

The above examples and implementations are not necessarily inclusive or exclusive of each other and may be combined in any manner that is non-conflicting and otherwise possible, whether they be presented in association with a same, or a different, embodiment or example or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above examples implementations are illustrative, rather than limiting.

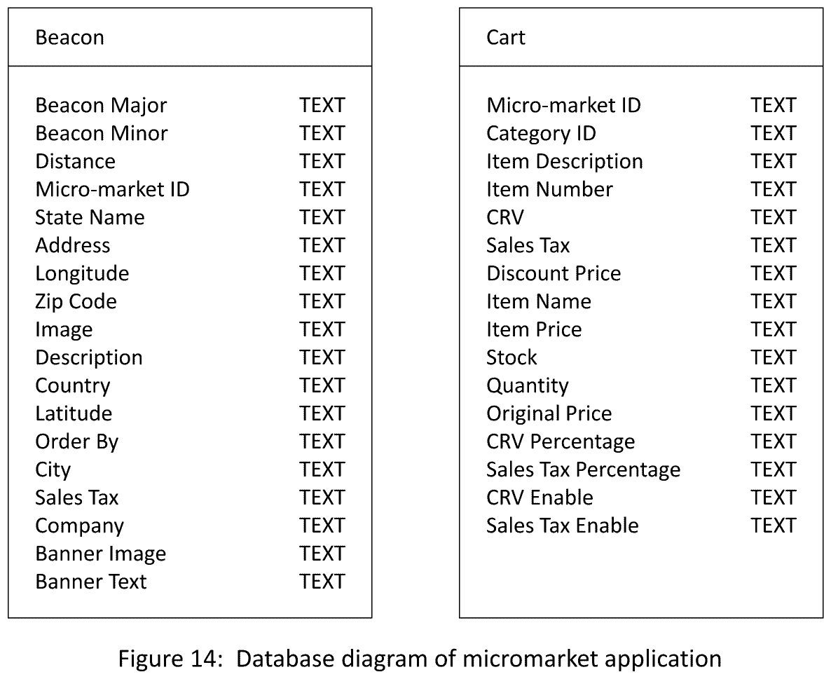

FIG. 14 is a simplified diagram of a database schema according to an example. In an example, the database diagram has a beacon and a cart. In an example, the micromarket application via Bluetooth is configured to constantly listen (or receive signals from) for a nearby BLE beacon that are advertising a UUID(s) (unique IDs). In an example, when the application detects a beacon that is advertising a UUID that it recognizes as its own (i.e., designated UUID), it then reads the Major and Minor values of that beacon. Based on the Major and Minor values of the beacon, the application fetches the respective micro market's name and location, the product categories and the products (their names, descriptions, and prices) within them, and the shopping cart from the server, which is now connected to the application. The data for each micro market is stored in the “Beacon” table in the application's database.

In an example, when a user is in the spatial region of the Bluetooth beacon signal, the Beacon table is populated with values fetched from the server for the respective micro market. When the user leaves the spatial region, the data from this table is deleted. In an example, the data for the user's shopping cart is stored in the “Cart” table within the application's database and is also duplicated in a table in the server's database. If the user leaves the spatial region of the Bluetooth beacon signal, the shopping cart and the products in it are no longer displayed in the application. When user re-enters the spatial region of the Bluetooth beacon signal, the shopping cart and the products in it are reloaded from the server and displayed in the application. This allows the user to maintain a shopping cart for each micro market, even if user walks away from the micro market and then returns to complete the purchase. In an example, the data in the “Cart” table is deleted if the user removes all products from the shopping cart, or completes the purchase.

In an example, various hardware elements of the invention can be implemented using a smart phone according to an embodiment of the present invention. As shown, the smart phone includes a housing, display, and interface device, which may include a button, microphone, or touch screen. Preferably, the phone has a high-resolution camera device, which can be used in various modes. An example of a smart phone can be an iPhone from Apple Computer of Cupertino California. Alternatively, the smart phone can be a Galaxy from Samsung or others.

In an example, the smart phone includes the following features (which are found in an iPhone from Apple Computer, although there can be variations), see www.apple.com, which is incorporated by reference. In an example, the phone can include 802.11b/g/n Wi-Fi (802.11n 2.4 GHz only), Bluetooth 2.1+EDR wireless technology, Assisted GPS, Digital compass, Wi-Fi, Cellular, Retina display, 5-megapixel iSight camera, Video recording, HD (720p) up to 30 frames per second with audio, Photo and video geotagging, Three-axis gyro, Accelerometer, Proximity sensor, and Ambient light sensor. Of course, there can be other variations, modifications, and alternatives.

An exemplary electronic device may be a portable electronic device, such as a media player, a cellular phone, a personal data organizer, or the like. Indeed, in such embodiments, a portable electronic device may include a combination of the functionalities of such devices. In addition, the electronic device may allow a user to connect to and communicate through the Internet or through other networks, such as local or wide area networks. For example, the portable electronic device may allow a user to access the internet and to communicate using e-mail, text messaging, instant messaging, or using other forms of electronic communication. By way of example, the electronic device may be a model of an iPod having a display screen or an iPhone available from Apple Inc.

In certain embodiments, the device may be powered by one or more rechargeable and/or replaceable batteries. Such embodiments may be highly portable, allowing a user to carry the electronic device while traveling, working, exercising, and so forth. In this manner and depending on the functionalities provided by the electronic device, a user may listen to music, play games or video, record video or take pictures, place and receive telephone calls, communicate with others, control other devices (e.g., via remote control and/or Bluetooth functionality), and so forth while moving freely with the device. In addition, device may be sized such that it fits relatively easily into a pocket or a hand of the user. While certain embodiments of the present invention are described with respect to a portable electronic device, it should be noted that the presently disclosed techniques may be applicable to a wide array of other, less portable, electronic devices and systems that are configured to render graphical data, such as a desktop computer.

In the presently illustrated embodiment, the exemplary device includes an enclosure or housing, a display, user input structures, and input/output connectors. The enclosure may be formed from plastic, metal, composite materials, or other suitable materials, or any combination thereof. The enclosure may protect the interior components of the electronic device from physical damage and may also shield the interior components from electromagnetic interference (EMI).

The display may be a liquid crystal display (LCD), a light emitting diode (LED) based display, an organic light emitting diode (OLED) based display, or some other suitable display. In accordance with certain embodiments of the present invention, the display may display a user interface and various other images, such as logos, avatars, photos, album art, and the like. Additionally, in one embodiment, the display may include a touch screen through which a user may interact with the user interface. The display may also include various function and/or system indicators to provide feedback to a user, such as power status, call status, memory status, or the like. These indicators may be incorporated into the user interface displayed on the display.

In an embodiment, one or more of the user input structures are configured to control the device, such as by controlling a mode of operation, an output level, an output type, etc. For instance, the user input structures may include a button to turn the device on or off. Further the user input structures may allow a user to interact with the user interface on the display. Embodiments of the portable electronic device may include any number of user input structures, including buttons, switches, a control pad, a scroll wheel, or any other suitable input structures. The user input structures may work with the user interface displayed on the device to control functions of the device and/or any interfaces or devices connected to or used by the device. For example, the user input structures may allow a user to navigate a displayed user interface or to return such a displayed user interface to a default or home screen.

The exemplary device may also include various input and output ports to allow connection of additional devices. For example, a port may be a headphone jack that provides for the connection of headphones. Additionally, a port may have both input/output capabilities to provide for connection of a headset (e.g., a headphone and microphone combination). Embodiments of the present invention may include any number of input and/or output ports, such as headphone and headset jacks, universal serial bus (USB) ports, IEEE-1394 ports, and AC and/or DC power connectors. Further, the device may use the input and output ports to connect to and send or receive data with any other device, such as other portable electronic devices, personal computers, printers, or the like. For example, in one embodiment, the device may connect to a personal computer via an IEEE-1394 connection to send and receive data files, such as media files. Further details of the device can be found in U.S. Pat. No. 8,294,730, assigned to Apple, Inc.

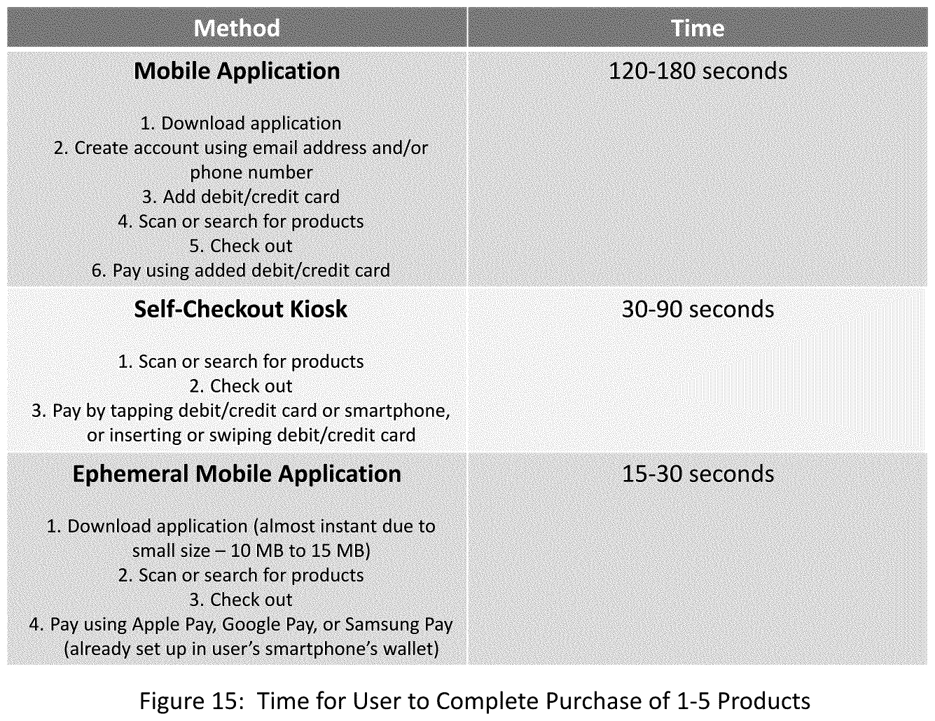

FIG. 15 is a simplified diagram illustrating a transaction process according to an example. As shown, the diagram illustrates various times to perform a transaction. As an example, a mobile application generally takes 120-180 seconds. A self check out kiosk takes 30-90 seconds, as long as the user knows what he/she is doing. The present ephemeral app takes 15-30 seconds to perform a transaction. Each of the transactions scan one or two products for purchase to make all variables equal.

In an example, the present ephemeral application includes the following steps without entering user information into the application, which makes it more efficient:
1. Display generic physical QR code for a specific app clip from a micromarket in a geographic region;
2. Scan QR code using a mobile device by a user;
3. Display screen indicating “Open”;
4. Hit Open;
5. Directly transfer to a mobile app store associated with the QR code on the mobile device without accessing a link to the internet;
6. Download the app clip which is less than 10 MB (without registration of the micromarket);
7. Display permission for using location services;
8. Hit allow to allow permission;
9. Read Bluetooth beacon unique identifier to connect app clip to selected market for the micromarket in the geographic region;
10. “Welcome to Market” is displayed on the mobile device;
11. Scan desired products using the mobile phone;
12. Initiate check out; and
13. Pay with Apple Pay or other payment program.

In an example, the above sequence of steps is merely an example. Steps can be added or removed, or modified depending upon the application. Further details of the present techniques can be found throughout the present specification and more particularly below.

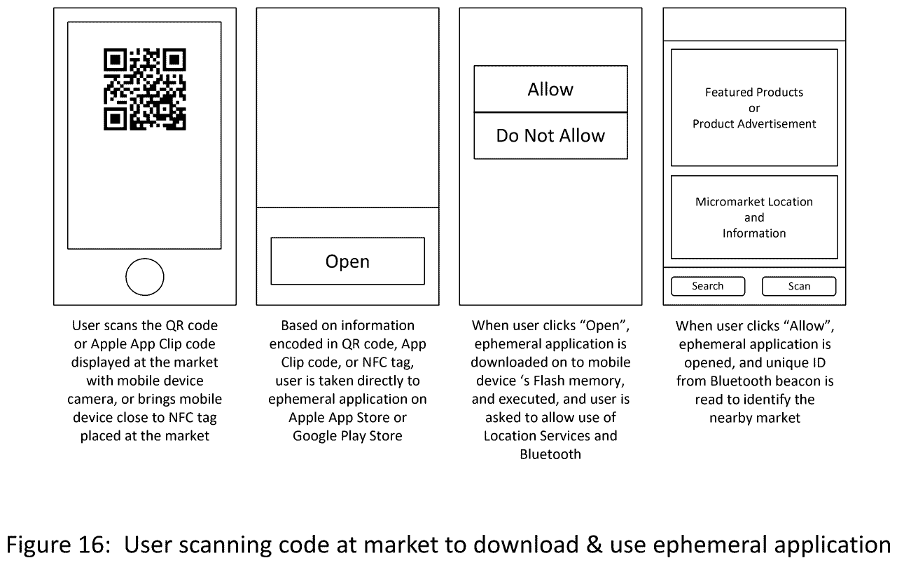

FIG. 16 illustrates simplified user interfaces to download and use the ephemeral app according to an example. As shown are the various steps and user interfaces that have been described. Further details of various examples can be found below.

In an example, the present invention provides a method for connecting to a communication network associated with a micro market. The method includes scanning a code associated with an ephemeral app to be downloaded to a mobile communication device. In an example, the mobile communication device is coupled to a communication network. The communication network is coupled a plurality of micro markets. Each of the micro markets has a catalog of products for sale. In an example, the method includes associating a web address with a code to find the ephemeral app and linking the web address with the mobile device.

In an example, the method includes transferring the ephemeral app in a first format using the Internet to a storage location on the mobile communication device, and initiating the ephemeral app onto the mobile device to open the ephemeral app. In an example, the method includes sensing for a Bluetooth beacon associated with a spatial area of one of the micro markets and connecting using the Internet to a server associated with the micro market to transfer the catalog and list of items associated with the micro market. As used herein, the term “first format” is a data format used to transmit the ephemeral app. The ephemeral app can be used in a second format. The terms “first” and “second” are not intended to be limiting or imply order.

In an example, the method includes selecting one or more of the items in the catalog in a shopping cart and checking out of the micro market by paying for the items using an online payment process. In an example, the method includes polling activity associated with the ephemeral app, and removing the ephemeral app from the storage location if no activity is detected from checking out after 24 hours, but can include variations, such as ten minutes, one hour, twelve hours, or others.

In an example, the ephemeral app has a size of 10 MB or less. In an example, the sensing comprises using a wireless Bluetooth™ connection to read a micro market beacon unique identification to determine a presence of a micro market having a transmitter device emitting the micro market beacon unique identification. In an example, the ephemeral application displaces the catalog of the products for sale at the micro market.

In an example, the initiating comprising downloading the ephemeral application automatically without any interaction of a user of the mobile communication device. In an example, the downloading is characterized by a time of 10 seconds and less.

In an example, the ephemeral application is configured for one of a plurality of micro markets, each of the micro markets having a transmitter capable of emitting a unique identification associated with the micro market. In an example, the code associated with the ephemeral app is displayed on a physical structure within a vicinity of the micro market. In an example, the ephemeral app is selected from an App Clip from Apple or a Google Play Instant App from Google Inc. In an example, the on-line payment process is selected from Apple Pay, Google Pay, Samsung Pay, or other mobile pay application.

In an example, the present invention provides a method for connecting to a communication network associated with a micro market. The method includes scanning a code associated with an ephemeral app to be downloaded to a mobile communication device. In an example, the mobile communication device is coupled to a communication network, e.g., wireless, wired. The communication network is coupled a plurality of micro markets. Each of the micro markets has a catalog of products for sale. In an example, the method includes associating a web address with a code to find the ephemeral app. In an example, the ephemeral app is configured without any user information, including at least one or more of a name, email address, a phone number, or other personal data. In an example, the method includes linking the web address with the mobile device and transferring the ephemeral app in a first format using the Internet to a storage location on the mobile communication device. The method includes initiating the ephemeral app onto the mobile device to open the ephemeral app and sensing for a Bluetooth beacon associated with a spatial area of one of the micro markets. The method includes connecting using the Internet to a server associated with the micro market to transfer the catalog and list of items associated with the micro market. The method includes selecting one or more of the items in the catalog in a shopping cart and checking out of the micro market by paying for the items using an online payment process configured with a wallet associated with the mobile device. In an example, the wallet comprises a plurality of payment cards. Each of the payment cards is pre-authorized for a user of the mobile communication device. In an example the method includes maintaining privacy of any user information associated with the user of the mobile communication device and
performing the scanning, associating, linking, transferring, initiating, sensing, connecting, selecting, and checking out within a time frame of 45 seconds and less. Preferably, the method includes polling activity associated with the ephemeral app, and removing the ephemeral app from the storage location if no activity is detected from checking out after 24 hours.

In an example, the invention provides an alternative method for connecting to a communication network associated with a micro market. The method comprises scanning a code associated with an ephemeral app to be downloaded to a mobile communication device. In an example, the mobile communication device is coupled to a communication network. The communication network is coupled a plurality of micro markets. Each of the micro markets has a catalog of products for sale. In an example, the method includes associating a web address with a code to find the ephemeral app. The ephemeral app is configured without any user information, including at least one or more of a name, email address, a phone number, or other personal data.

In an example, the method includes linking the web address with the mobile device, transferring the ephemeral app in a first format using the Internet to a storage location on the mobile communication device, and initiating the ephemeral app onto the mobile device to open the ephemeral app.

In an example, the method includes sensing for a Bluetooth beacon associated with a spatial area of one of the micro markets. The method includes connecting using the Internet to a server associated with the micro market to transfer the catalog and list of items associated with the micro market. In an example, the Bluetooth beacon is associated with a micromarket unique identification for the spatial area of one of the micro markets. The method includes selecting one or more of the items in the catalog in a shopping cart and checking out of the micro market by paying for the items using an online payment process configured with a wallet associated with the mobile device. The wallet comprises a plurality of payment cards or at least one. Each of the payment cards is pre-authorized by a third party for a user of the mobile communication device. The method includes maintaining privacy of any user information associated with the user of the mobile communication device. Preferably, the method includes polling activity associated with the ephemeral app, and removing the ephemeral app from the storage location if no activity is detected from checking out after 24 hours.

Although the description has been provided for transfer of goods, other things or services can also be included depending upon the application.

Having described various embodiments, examples, and implementations, it should be apparent to those skilled in the relevant art that the foregoing is illustrative only and not limiting, having been presented by way of example only. Many other schemes for distributing functions among the various functional elements of the illustrated embodiment or example are possible. The functions of any element may be carried out in various ways in alternative embodiments or examples.

Also, the functions of several elements may, in alternative embodiments or examples, be carried out by fewer, or a single, element. Similarly, in some embodiments, any functional element may perform fewer, or different, operations than those described with respect to the illustrated embodiment or example. Also, functional elements shown as distinct for purposes of illustration may be incorporated within other functional elements in a particular implementation. Also, the sequencing of functions or portions of functions generally may be altered. Certain functional elements, files, data structures, and so one may be described in the illustrated embodiments as located in system memory of a particular or hub. In other embodiments, however, they may be located on, or distributed across, systems or other platforms that are co-located and/or remote from each other. For example, any one or more of data files or data structures described as co-located on and “local” to a server or other computer may be located in a computer system or systems remote from the server. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures of files may be used and various described data structures of files may be combined or otherwise arranged.

In other examples, combinations or sub-combinations of the above disclosed invention can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method for connecting to a communication network associated with a micro market, the method comprising:
scanning a code associated with an ephemeral app to be downloaded to a mobile communication device, the mobile communication device being coupled to a communication network, the communication network being coupled a plurality of micro markets, each of the micro markets having a catalog of products for sale;
associating a web address with a code to find the ephemeral app, the ephemeral app being configured without any user information, including at least one or more of a name, email address, a phone number, or other personal data;
linking the web address with the mobile device;
transferring the ephemeral app in a first format using the Internet to a storage location on the mobile communication device;
initiating the ephemeral app onto the mobile device to open the ephemeral app in a second format;
sensing for a Bluetooth beacon associated with a spatial area of one of the micro markets;
connecting using the Internet to a server associated with the micro market to transfer the catalog and list of items associated with the micro market, the Bluetooth beacon being associated with a micromarket unique identification for the spatial area of one of the micro markets;
selecting one or more of the items in the catalog in a shopping cart;
checking out of the micro market by paying for the items using an online payment process configured with a wallet associated with the mobile device, the wallet comprising a plurality of payment cards, each of the payment cards being pre-authorized for a user of the mobile communication device;
maintaining privacy of any user information associated with the user of the mobile communication device; and
polling activity associated with the ephemeral app, and removing the ephemeral app from the storage location if no activity is detected from checking out after 24 hours.

2. The method of claim 1 wherein the ephemeral app has a size of 10 MB or less.

3. The method of claim 1 wherein the sensing comprises using a wireless Bluetooth™ connection to read the micro market beacon unique identification to determine a presence of a micro market having a transmitter device emitting the micro market beacon unique identification.

4. The method of claim 3 wherein the ephemeral application displaces the catalog of the products for sale at the micro market.

5. The method of claim 1 wherein the initiating comprising downloading the ephemeral application automatically without any interaction of a user of the mobile communication device.

6. The method of claim 5 wherein the downloading is characterized by a time of 10 seconds and less.

7. The method of claim 1 wherein the ephemeral application is configured for one of a plurality of micro markets, each of the micro markets having a transmitter capable of emitting a unique identification associated with the micro market.

8. The method of claim 1 wherein the code associated with the ephemeral app is displayed on a physical structure within a vicinity of the micro market.

9. The method of claim 1 wherein the ephemeral app is selected from an App Clip from Apple or a Google Play Instant App from Google Inc.

10. The method of claim 1 wherein the on-line payment process is selected from Apple Pay, Google Pay, Samsung Pay, or other mobile pay application.

11. A method for connecting to a communication network associated with a micro market, the method comprising:
scanning a code associated with an ephemeral app to be downloaded to a mobile communication device, the mobile communication device being coupled to a communication network, the communication network being coupled a plurality of micro markets, each of the micro markets having a catalog of products for sale;
associating a web address with a code to find the ephemeral app, the ephemeral app being configured without any user information, including at least one or more of a name, email address, a phone number, or other personal data;
linking the web address with the mobile device;
transferring the ephemeral app in a first format using the Internet to a storage location on the mobile communication device;
initiating the ephemeral app onto the mobile device to open the ephemeral app;
sensing for a Bluetooth beacon associated with a spatial area of one of the micro markets;
connecting using the Internet to a server associated with the micro market to transfer the catalog and list of items associated with the micro market;
selecting one or more of the items in the catalog in a shopping cart;
checking out of the micro market by paying for the items using an online payment process configured with a wallet associated with the mobile device, the wallet comprising a plurality of payment cards, each of the payment cards being pre-authorized for a user of the mobile communication device;
maintaining privacy of any user information associated with the user of the mobile communication device;
performing the scanning, associating, linking, transferring, initiating, sensing, connecting, selecting, and checking out within a time frame of 45 seconds and less; and
polling activity associated with the ephemeral app, and removing the ephemeral app from the storage location if no activity is detected from checking out after one hour.

12. The method of claim 11 wherein the ephemeral app has a size of 10 MB or less.

13. The method of claim 11 wherein the sensing comprises using a wireless Bluetooth™ connection to read a micro market beacon unique identification to determine a presence of a micro market having a transmitter device emitting the micro market beacon unique identification.

14. The method of claim 13 wherein the ephemeral application displaces the catalog of the products for sale at the micro market.

15. The method of claim 11 wherein the initiating comprising downloading the ephemeral application automatically without any interaction of a user of the mobile communication device.

16. The method of claim 15 wherein the downloading is characterized by a time of 10 seconds and less.

17. The method of claim 11 wherein the ephemeral application is configured for one of a plurality of micro markets, each of the micro markets having a transmitter capable of emitting a unique identification associated with the micro market.

18. The method of claim 11 wherein the code associated with the ephemeral app is displayed on a physical structure within a vicinity of the micro market.

19. The method of claim 11 wherein the ephemeral app is selected from an App Clip from Apple or an Instant App from Google Inc.

20. The method of claim 11 wherein the on-line payment process is selected from Apple Pay, Google Pay, Samsung Pay, or other mobile pay application.
